(19) United States
(12) Patent Application Publication
(10) Pub. No.: US 2026/0260070 A1
(43) Pub. Date: Sep. 3, 2026

(54) SYSTEMS AND METHODS FOR AN INTELLIGENT INTENT ENGINE

(71) Applicant: Truist Bank, Charlotte, NC (US)

(72) Inventors: Keyur Prakash Dave, Charlotte, NC (US); Himanshu Johri, Charlotte, NC (US); Vijay Srinivasan, Charlotte, NC (US); Karthik Paneerselvam, Charlotte, NC (US); Adisheshu Shavi, Charlotte, NC (US); Abhay Vijay Mone, Charlotte, NC (US); Bargavi Chinthagumpallu, Charlotte, NC (US); Madhavi Vegesna, Charlotte, NC (US); Harish Dindi, Charlotte, NC (US)

(73) Assignee: Truist Bank, Charlotte, NC (US)

(21) Appl. No.: 19/066,591

(22) Filed: Feb. 28, 2025

(51) Int. Cl. G06F 40/30; G10L 15/26; H04L 51/02

(52) U.S. Cl. CPC G06F 40/30; G10L 15/26; H04L 51/02

(57) ABSTRACT

A method, computer program product, and computer system for receiving, by a chatbot executing on a computing device, information from a user at a given point in time, wherein the information is associated with an object. A plurality of models may be executed to analyze the information associated with the object. It may be predicted that the user requires additional information for the object based upon, at least in part, analyzing the information received by the user at the given point in time. The chatbot may preemptively provide the additional information for the object to the user based upon, at least in part, predicting that the user requires the additional information for the object.

### TECHNICAL FIELD

The present disclosure relates to a chatbot application, and more particularly, to a chatbot application to intelligently predict the intent of a user and preemptively provide desired information to the user.

### BACKGROUND

The ability to obtain information has improved greatly over the years. As a result, a vast amount of information is available, often times through a single client application.

### SUMMARY

In one example implementation, a computer-implemented method, performed by one or more computing devices, may include but is not limited to receiving, by a chatbot executing on a computing device, information from a user at a given point in time, wherein the information is associated with an object. A plurality of models may be executed to analyze the information associated with the object. It may be predicted that the user requires additional information for the object based upon, at least in part, analyzing the information received by the user at the given point in time. The chatbot may preemptively provide the additional information for the object to the user based upon, at least in part, predicting that the user requires the additional information for the object.

One or more of the following example features may be included. A first model of the plurality of models executed to analyze the information associated with the object may include a natural language understanding (NLU) model for intent identification. A second model of the plurality of models executed to analyze the information associated with the object may include an Automated Speech Recognition (ASR) model to transcribe audio of at least a portion of the information that is analyzed by the NLU model. Predicting that the user requires additional information for the object may include predicting that the user requires help navigating through a client application. Preemptively providing, by the chatbot, the additional information for the object to the user may include providing step by step instructions how to navigate through the client application. Preemptively providing, by the chatbot, the additional information for the object to the user may include providing a selectable link to the additional information, wherein the selectable link, when selected, may navigate directly to the additional information through the client application. The additional information for the object may include a recommendation for another object.

In another example implementation, a computing system may include one or more processors and one or more memories configured to perform operations that may include but are not limited to receiving, by a chatbot executing on a computing device, information from a user at a given point in time, wherein the information is associated with an object. A plurality of models may be executed to analyze the information associated with the object. It may be predicted that the user requires additional information for the object based upon, at least in part, analyzing the information received by the user at the given point in time. The chatbot may preemptively provide the additional information for the object to the user based upon, at least in part, predicting that the user requires the additional information for the object.

One or more of the following example features may be included. A first model of the plurality of models executed to analyze the information associated with the object may include a natural language understanding (NLU) model for intent identification. A second model of the plurality of models executed to analyze the information associated with the object may include an Automated Speech Recognition (ASR) model to transcribe audio of at least a portion of the information that is analyzed by the NLU model. Predicting that the user requires additional information for the object may include predicting that the user requires help navigating through a client application. Preemptively providing, by the chatbot, the additional information for the object to the user may include providing step by step instructions how to navigate through the client application. Preemptively providing, by the chatbot, the additional information for the object to the user may include providing a selectable link to the additional information, wherein the selectable link, when selected, may navigate directly to the additional information through the client application. The additional information for the object may include a recommendation for another object.

In another example implementation, a computer program product may reside on a computer readable storage medium having a plurality of instructions stored thereon which, when executed across one or more processors, may cause at least a portion of the one or more processors to perform operations that may include but are not limited to receiving, by a chatbot executing on a computing device, information from a user at a given point in time, wherein the information is associated with an object. A plurality of models may be executed to analyze the information associated with the object. It may be predicted that the user requires additional information for the object based upon, at least in part, analyzing the information received by the user at the given point in time. The chatbot may preemptively provide the additional information for the object to the user based upon, at least in part, predicting that the user requires the additional information for the object.

One or more of the following example features may be included. A first model of the plurality of models executed to analyze the information associated with the object may include a natural language understanding (NLU) model for intent identification. A second model of the plurality of models executed to analyze the information associated with the object may include an Automated Speech Recognition (ASR) model to transcribe audio of at least a portion of the information that is analyzed by the NLU model. Predicting that the user requires additional information for the object may include predicting that the user requires help navigating through a client application. Preemptively providing, by the chatbot, the additional information for the object to the user may include providing step by step instructions how to navigate through the client application. Preemptively providing, by the chatbot, the additional information for the object to the user may include providing a selectable link to the additional information, wherein the selectable link, when selected, may navigate directly to the additional information through the client application. The additional information for the object may include a recommendation for another object.

The details of one or more example implementations are set forth in the accompanying drawings and the description below. Other possible example features and/or possible example advantages will become apparent from the description, the drawings, and the claims. Some implementations may not have those possible example features and/or possible example advantages, and such possible example features and/or possible example advantages may not necessarily be required of some implementations.

### DRAWINGS

FIG. 1 is an example diagrammatic view of an intent process coupled to an example distributed computing network according to one or more example implementations of the disclosure;

FIG. 2 is an example diagrammatic view of a computing device of FIG. 1 according to one or more example implementations of the disclosure;

FIG. 3 is an example flowchart of an intent process according to one or more example implementations of the disclosure;

FIG. 4 is an example diagrammatic view of an example user interface according to one or more example implementations of the disclosure;

FIG. 5 is an example diagrammatic view of an example user interface according to one or more example implementations of the disclosure; and

FIG. 6 is an example diagrammatic view of an example user interface according to one or more example implementations of the disclosure.

Like reference symbols in the various drawings indicate like elements.

### DESCRIPTION

### System Overview

In some implementations, the present disclosure may be embodied as a method, system, or computer program product. Accordingly, in some implementations, the present disclosure may take the form of an entirely hardware implementation, an entirely software implementation (including firmware, resident software, micro-code, etc.) or an implementation combining software and hardware aspects that may all generally be referred to herein as a “circuit,” “module” or “system.” Furthermore, in some implementations, the present disclosure may take the form of a computer program product on a computer-usable storage medium having computer-usable program code embodied in the medium.

Software may include artificial intelligence (AI) systems, which may include machine learning or other computational intelligence. For example, AI may include one or more models used for one or more problem domains. When presented with many data features, identification of a subset of features that are relevant to a problem domain may improve prediction accuracy, reduce storage space, and increase processing speed. This identification may be referred to as feature engineering. Feature engineering may be performed by users or may only be guided by users. In various implementations, a machine learning system may computationally identify relevant features, such as by performing singular value decomposition on the contributions of different features to outputs.

In some implementations, the various computing devices may include, integrate with, link to, exchange data with, be governed by, take inputs from, and/or provide outputs to one or more AI systems, which may include models, rule-based systems, expert systems, neural networks, deep learning systems, supervised learning systems, robotic process automation systems, natural language processing systems, intelligent agent systems, self-optimizing and self-organizing systems, and others. Except where context specifically indicates otherwise, references to AI, or to one or more examples of AI, should be understood to encompass one or more of these various alternative methods and systems; for example, without limitation, an AI system described for enabling any of a wide variety of functions, capabilities and solutions described herein (such as optimization, autonomous operation, prediction, control, orchestration, or the like) should be understood to be capable of implementation by operation on a model or rule set; by training on a training data set of human tag, labels, or the like; by training on a training data set of human interactions (e.g., human interactions with software interfaces or hardware systems); by training on a training data set of outcomes; by training on an AI-generated training data set (e.g., where a full training data set is generated by AI from a seed training data set); by supervised learning; by semi-supervised learning; by deep learning; or the like. For any given function or capability that is described herein, neural networks of various types may be used, including any of the types described herein, and in embodiments a hybrid set of neural networks may be selected such that within the set a neural network type that is more favorable for performing each element of a multi-function or multi-capability system or method is implemented. As one example among many, a deep learning, or black box, system may use a gated recurrent neural network for a function like language translation for an intelligent agent, where the underlying mechanisms of AI operation need not be understood as long as outcomes are favorably perceived by users, while a more transparent model or system and a simpler neural network may be used for a system for automated governance, where a greater understanding of how inputs are translated to outputs may be needed to comply with regulations or policies.

Examples of the models (e.g., AI-based models) include recurrent neural networks (RNNs) such as long short-term memory (LSTM), deep learning models such as transformers, decision trees, support-vector machines, genetic algorithms, Bayesian networks, and regression analysis. Examples of systems based on a transformer model include bidirectional encoder representations from transformers (BERT) and generative pre-trained transformers (GPT). Training a machine-learning model (or other type of AI-based learning models) may include supervised learning (for example, based on labelled input data), unsupervised learning, and reinforcement learning. In various embodiments, a machine-learning model may be pre-trained by their operator or by a third party. Problem domains include nearly any situation where structured data can be collected, and includes natural language processing (NLP), including natural language understanding (NLU), computer vision (CV), classification, image recognition, etc. Some or all of the software may run in a virtual environment rather than directly on hardware. The virtual environment may include a hypervisor, emulator, sandbox, container engine, etc. The software may be built as a virtual machine, a container, etc. Virtualized resources may be controlled using, for example, a DOCKER container platform, a pivotal cloud foundry (PCF) platform, etc. Some or all of the software may be logically partitioned into microservices. Each microservice offers a reduced subset of functionality. In various embodiments, each microservice may be scaled independently depending on load, either by devoting more resources to the microservice or by instantiating more instances of the microservice. In various embodiments, functionality offered by one or more microservices may be combined with each other and/or with other software not adhering to a microservices model.

In some implementations, as noted above, AI-based learning models may include at least one of a transformer model, a convolutional neural network, a deep learning model trained on a set of outcomes of the value chain network entity, a supervised model, a semi-supervised model, an unsupervised model, or a reinforcement model, and the training data set for the AI-based learning models may include one or a set of objects or events that are labeled to classify the set of objects or events according to a classification taxonomy. Other examples of AI-based learning models (e.g., machine learning models) may include neural networks in general (e.g., deep neural networks, convolution neural networks, and many others), regression-based models, decision trees, hidden forests, Hidden Markov models, Bayesian models, and the like. In some implementations, the present disclosure may include combinations where an expert system uses one neural network for classifying an item and a different (or the same) neural network for predicting a state of the item.

In some implementations, any suitable computer usable or computer readable medium (or media) may be utilized. The computer readable medium may be a computer readable signal medium or a computer readable storage medium. The computer-usable, or computer-readable, storage medium (including a storage device associated with a computing device or client electronic device) may be, for example, but is not limited to, an electronic, magnetic, optical, electromagnetic, infrared, or semiconductor system, apparatus, device, or any suitable combination of the foregoing. More specific examples (a non-exhaustive list) of the computer-readable medium or storage device may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, solid state drives (SSDs), a digital versatile disk (DVD), a Blu-ray disc, and an Ultra HD Blu-ray disc, a static random access memory (SRAM), dynamic RAM (DRAM), synchronous DRAM (SDRAM), synchronous graphics RAM (SGRAM), and video RAM (VRAM), analog magnetic tape, digital magnetic tape, rotating hard disk drive (HDDs), a memory stick, a floppy disk, a mechanically encoded device such as punch-cards or raised structures in a groove having instructions recorded thereon, a media such as those supporting the internet or an intranet, or a magnetic storage device. Note that the computer-usable or computer-readable medium could even be a suitable medium upon which the program is stored, scanned, compiled, interpreted, or otherwise processed in a suitable manner, if necessary, and then stored in a computer memory. In the context of the present disclosure, a computer-usable or computer-readable, storage medium may be any tangible medium that can contain or store a program for use by or in connection with the instruction execution system, apparatus, or device.

Examples of storage implemented by the storage hardware include a distributed ledger, such as a permissioned or permissionless blockchain. Entities recording transactions, such as in a blockchain, may reach consensus using an algorithm such as proof-of-stake, proof-of-work, and proof-of-storage. Elements of the present disclosure may be represented by or encoded as non-fungible tokens (NFTs). Ownership rights related to the non-fungible tokens may be recorded in or referenced by a distributed ledger. Transactions initiated by or relevant to the present disclosure may use one or both of fiat currency and cryptocurrencies, examples of which include bitcoin and ether.

In some implementations, a computer readable signal medium may include a propagated data signal with computer readable program code embodied therein, for example, in baseband or as part of a carrier wave. In some implementations, such a propagated signal may take any of a variety of forms, including, but not limited to, electro-magnetic, optical, or any suitable combination thereof. In some implementations, the computer readable program code may be transmitted using any appropriate medium, including but not limited to the internet, wireline, optical fiber cable, RF, etc. In some implementations, a computer readable signal medium may be any computer readable medium that is not a computer readable storage medium and that can communicate, propagate, or transport a program for use by or in connection with an instruction execution system, apparatus, or device.

In some implementations, computer program code for carrying out operations of the present disclosure may be assembler instructions, instruction-set-architecture (ISA) instructions, machine instructions, machine dependent instructions, microcode, firmware instructions, state-setting data, state information that personalizes electronic circuitry and/or other structural components that are native to hardware (e.g., host processor, central processing unit/CPU, microcontroller, etc.) or either source code or object code written in any combination of one or more programming languages, including an object oriented programming language such as Java®, Smalltalk, C++ or the like. Java® and all Java-based trademarks and logos are trademarks or registered trademarks of Oracle and/or its affiliates. However, the computer program code for carrying out operations of the present disclosure may also be written in conventional procedural programming languages, such as the “C” programming language, PASCAL, or similar programming languages, as well as in scripting languages such as JavaScript, PERL, or Python. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a network, such as a cellular network, local area network (LAN), a wide area network (WAN), a body area network BAN), a personal area network (PAN), a metropolitan area network (MAN), etc., or the connection may be made to an external computer (for example, through the internet using an Internet Service Provider). The networks may include one or more of point-to-point and mesh technologies. Data transmitted or received by the networking components may traverse the same or different networks. Networks may be connected to each other over a WAN or point-to-point leased lines using technologies such as Multiprotocol Label Switching (MPLS) and virtual private networks (VPNs), etc. In some implementations, electronic circuitry including, for example, programmable logic circuitry, an application specific integrated circuit (ASIC), gate arrays such as field-programmable gate arrays (FPGAs) or other hardware accelerators, micro-controller units (MCUs), or programmable logic arrays (PLAs), integrated circuits (ICs), digital circuit elements, analog circuit elements, combinational logic circuits, digital signal processors (DSPs), complex programmable logic devices (CPLDs), memory chips, network chips, systems on chip (SoCs), SSD/NAND controller ASICs, and the like, etc. may execute the computer readable program instructions/code by utilizing state information of the computer readable program instructions to personalize the electronic circuitry, in order to perform aspects of the present disclosure. Configurable or fixed-functionality logic may be implemented with complementary metal oxide semiconductor (CMOS) logic circuits, transistor-transistor logic (TTL) logic circuits, or other circuits. Multiple components of the hardware may be integrated, such as on a single die, in a single package, or on a single printed circuit board or logic board. For example, multiple components of the hardware may be implemented as a system-on-chip. A component, or a set of integrated components, may be referred to as a chip, chipset, chiplet, or chip stack. Examples of a system-on-chip include a radio frequency (RF) system-on-chip, an AI system-on-chip, a video processing system-on-chip, an organ-on-chip, a quantum algorithm system-on-chip, etc.

Examples of processing hardware may include, e.g., a central processing unit (CPU), a graphics processing unit (GPU), an accelerator (e.g., an AI accelerator), an approximate computing processor, a quantum computing processor, a parallel computing processor, a neural network processor, a signal processor, a digital processor, an analog processor, a data processor, an embedded processor, a microprocessor, and a co-processor. The co-processor may provide additional processing functions and/or optimizations, such as for speed or power consumption. Examples of a co-processor include a math co-processor, a graphics co-processor, a communication co-processor, a video co-processor, and an AI co-processor.

In some implementations, the AI accelerator may include suitable logic, circuitry, and/or interfaces to accelerate artificial intelligence applications, such as, e.g., artificial neural networks, machine vision and machine learning applications, including through parallel processing techniques. In one or more examples, the AI accelerator may include hardware logic or devices such as, e.g., a GPU or an FPGA. The AI accelerator may be used with any of the devices, components, features or methods described herein.

In some implementations, the flowchart and block diagrams in the figures illustrate the architecture, functionality, and operation of possible implementations of apparatus (systems), methods and computer program products according to various implementations of the present disclosure. Each block in the flowchart and/or block diagrams, and combinations of blocks in the flowchart and/or block diagrams, may represent a module, segment, or portion of code, which comprises one or more executable computer program instructions for implementing the specified logical function(s)/act(s). These computer program instructions may be provided to a processor of a general purpose computer, special purpose computer, or other programmable data processing apparatus to produce a machine, such that the computer program instructions, which may execute via the processor of the computer or other programmable data processing apparatus, create the ability to implement one or more of the functions/acts specified in the flowchart and/or block diagram block or blocks or combinations thereof. It should be noted that, in some implementations, the functions noted in the block(s) may occur out of the order noted in the figures (or combined or omitted). For example, two blocks shown in succession may, in fact, be executed substantially concurrently, or the blocks may sometimes be executed in the reverse order, depending upon the functionality involved. In addition, in some of the drawings, signal conductor lines may be represented with lines. Some may be different, to indicate more constituent signal paths, have a number label, to indicate a number of constituent signal paths, and/or have arrows at one or more ends, to indicate primary information flow direction(s). This, however, should not be construed in a limiting manner. Rather, such added detail may be used in connection with one or more implementations to facilitate ease of understanding. Any represented lines, whether or not having additional information, may actually comprise one or more signals/information that may travel in multiple directions and may be implemented with any suitable type of signal scheme, e.g., digital or analog lines implemented with differential pairs, optical fiber lines, and/or single-ended lines, etc.

In some implementations, these computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks or combinations thereof.

In some implementations, the computer program instructions may also be loaded onto a computer or other programmable data processing apparatus to cause a series of operational steps to be performed (not necessarily in a particular order) on the computer or other programmable apparatus to produce a computer implemented process such that the instructions which execute on the computer or other programmable apparatus provide steps for implementing the functions/acts (not necessarily in a particular order) specified in the flowchart and/or block diagram block or blocks or combinations thereof.

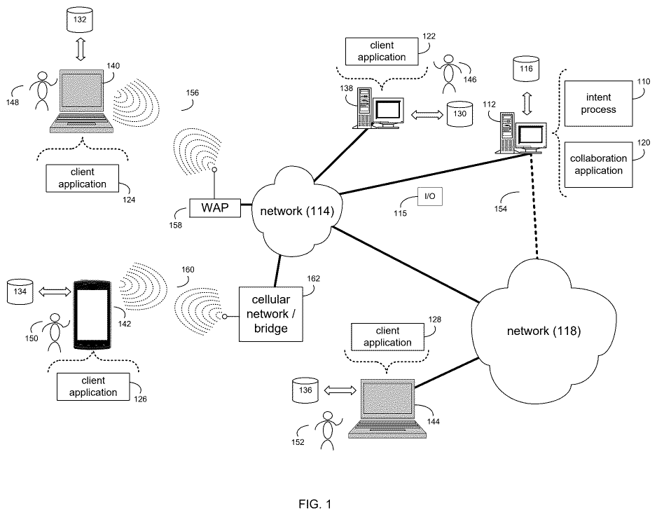

Referring now to the example implementation of FIG. 1, there is shown intent process 110 that may reside on and may be executed by a computer (e.g., computer 112), which may be connected to a network (e.g., network 114) (e.g., the internet or a local area network). Examples of computer 112 (and/or one or more of the client electronic devices noted below) may include, but are not limited to, a storage system (e.g., a Network Attached Storage (NAS) system, a Storage Area Network (SAN)), a personal computer(s), a laptop computer(s), mobile computing device(s), a server computer, a series of server computers, a mainframe computer(s), or a computing cloud(s). A SAN may include one or more of the client electronic devices, including a RAID device and a NAS system. In some implementations, each of the aforementioned may be generally described as a computing device. In certain implementations, a computing device may be a physical or virtual device. In many implementations, a computing device may be any device capable of performing operations, such as a dedicated processor, a portion of a processor, a virtual processor, a portion of a virtual processor, portion of a virtual device, or a virtual device. In some implementations, a processor may be a physical processor or a virtual processor. In some implementations, a virtual processor may correspond to one or more parts of one or more physical processors. In some implementations, the instructions/logic may be distributed and executed across one or more processors, virtual or physical, to execute the instructions/logic. Computer 112 may execute an operating system, for example, but not limited to, Microsoft® Windows®; Mac® OS X®; Red Hat® Linux®, Windows® Mobile, Chrome OS, Blackberry OS, Fire OS, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

In some implementations, as will be discussed below in greater detail, a intent process, such as intent process 110 of FIG. 1, may receive, by a chatbot executing on a computing device, information from a user at a given point in time, wherein the information is associated with an object. A plurality of models may be executed to analyze the information associated with the object. It may be predicted that the user requires additional information for the object based upon, at least in part, analyzing the information received by the user at the given point in time. The chatbot may preemptively provide the additional information for the object to the user based upon, at least in part, predicting that the user requires the additional information for the object.

In some implementations, the instruction sets and subroutines of intent process 110, which may be stored on storage device, such as storage device 116, coupled to computer 112, may be executed by one or more processors and one or more memory architectures included within computer 112. In some implementations, storage device 116 may include but is not limited to: a hard disk drive; all forms of flash memory storage devices; a tape drive; an optical drive; a RAID array (or other array); a random access memory (RAM); a read-only memory (ROM); or combination thereof. In some implementations, storage device 116 may be organized as an extent, an extent pool, a RAID extent (e.g., an example 4D+1P R5 , where the RAID extent may include, e.g., five storage device extents that may be allocated from, e.g., five different storage devices), a mapped RAID (e.g., a collection of RAID extents), or combination thereof.

In some implementations, network 114 may be connected to one or more secondary networks (e.g., network 118), examples of which may include but are not limited to: a local area network; a wide area network or other telecommunications network facility; or an intranet, for example. The phrase “telecommunications network facility,” as used herein, may refer to a facility configured to transmit, and/or receive transmissions to/from one or more mobile client electronic devices (e.g., cellphones, etc.) as well as many others.

In some implementations, computer 112 may include a data store, such as a database (e.g., relational database, object-oriented database, triplestore database, etc.), a data store, a data lake, a column store, and/or a data warehouse, and may be located within any suitable memory location, such as storage device 116 coupled to computer 112. In some implementations, data, metadata, information, etc. described throughout the present disclosure may be stored in the data store. In some implementations, computer 112 may utilize any known database management system such as, but not limited to, DB2, in order to provide multi-user access to one or more databases, such as the above noted relational database. In some implementations, the data store may also be a custom database, such as, for example, a flat file database or an XML database. In some implementations, any other form(s) of a data storage structure and/or organization may also be used. In some implementations, intent process 110 may be a component of the data store, a standalone application that interfaces with the above noted data store and/or an applet/application that is accessed via client applications 122, 124, 126, 128. In some implementations, the above noted data store may be, in whole or in part, distributed in a cloud computing topology. In this way, computer 112 and storage device 116 may refer to multiple devices, which may also be distributed throughout the network.

In some implementations, computer 112 may execute a collaboration application (e.g., collaboration application 120), examples of which may include, but are not limited to, e.g., an automatic speech recognition (ASR) application (e.g., modeling, transcription, etc.), a natural language understanding (NLU)/natural language processing (NLP) application (e.g., machine learning, intent discovery, etc.), a text to speech (TTS) application (e.g., context awareness, learning, etc.), a speech signal enhancement (SSE) application (e.g., multi-zone processing/beamforming, noise suppression, etc.), a voice biometrics/wake-up-word processing application, a web conferencing application, a video conferencing application, a telephony application, a voice-over-IP application, a video-over-IP application, an Instant Messaging (IM)/“chat” application, a chatbot application, an interactive voice response (IVR) application, a short messaging service (SMS)/multimedia messaging service (MMS) application, or other application that allows for virtual meeting and/or remote collaboration. In some implementations, intent process 110 and/or collaboration application 120 may be accessed via one or more of client applications 122, 124, 126, 128. In some implementations, intent process 110 may be a standalone application, or may be an applet/application/script/extension that may interact with and/or be executed within collaboration application 120, a component of collaboration application 120, and/or one or more of client applications 122, 124, 126, 128. In some implementations, collaboration application 120 may be a standalone application, or may be an applet/application/script/extension that may interact with and/or be executed within intent process 110, a component of intent process 110, and/or one or more of client applications 122, 124, 126, 128. In some implementations, one or more of client applications 122, 124, 126, 128 may be a standalone application, or may be an applet/application/script/extension that may interact with and/or be executed within and/or be a component of intent process 110 and/or collaboration application 120. Examples of client applications 122, 124, 126, 128 may include, but are not limited to, e.g., a VR application, XR or MR application, an AR application, an automatic speech recognition (ASR) application (e.g., modeling, transcription, etc.), a natural language understanding (NLU)/natural language processing (NLP) application (e.g., machine learning, intent discovery, etc.), a text to speech (TTS) application (e.g., context awareness, learning, etc.), a speech signal enhancement (SSE) application (e.g., multi-zone processing/beamforming, noise suppression, etc.), a voice biometrics/wake-up-word processing application, a web conferencing application, a video conferencing application, a telephony application, a voice-over-IP application, a video-over-IP application, an Instant Messaging (IM)/“chat” application, a chatbot application, an interactive voice response (IVR) application, a short messaging service (SMS)/multimedia messaging service (MMS) application, or other application that allows for virtual meeting and/or remote collaboration, a virtual assistant application, a standard and/or mobile web browser, an email application (e.g., an email client application), a textual and/or a graphical user interface, a customized web browser, a plugin, an Application Programming Interface (API), or a custom application. The instruction sets and subroutines of client applications 122, 124, 126, 128, which may be stored on storage devices 130, 132, 134, 136, may be executed by one or more processors and one or more memory architectures incorporated into client electronic devices 138, 140, 142, 144.

In some implementations, one or more of storage devices 130, 132, 134, 136, may include but are not limited to: hard disk drives; flash drives, tape drives; optical drives; RAID arrays; random access memories (RAM); and read-only memories (ROM). Examples of client electronic devices 138, 140, 142, 144 (and/or computer 112) may include, but are not limited to, a personal computer (e.g., client electronic device 138), a laptop computer (e.g., client electronic device 140), a smart/data-enabled, cellular phone (e.g., client electronic device 142), a notebook computer (e.g., client electronic device 144), a tablet, a server, a television, a smart television, a smart speaker, an Internet of Things (IoT) device, a media (e.g., audio/video, photo, etc.) capturing and/or output device, an audio input and/or recording device (e.g., a handheld microphone, a lapel microphone, an embedded microphone/speaker (such as those embedded within eyeglasses, smart phones, tablet computers, smart televisions, smart speakers, watches, etc.), an infotainment device (e.g., such as those found in vehicles combining information and/or entertainment with optional screens and/or audio for such things as navigation, multimedia, connectivity, voice control, smartphone integration, touchscreen interface, internet and apps, rear-seat entertainment, etc.), a dedicated network device, and combinations thereof. Client electronic devices 138, 140, 142, 144 may each execute an operating system, examples of which may include but are not limited to, Android™, Apple® iOS®, Mac® OS X®; Red Hat® Linux®, Windows® Mobile, Chrome OS, Blackberry OS, Fire OS, or a custom operating system.

In some implementations, one or more of client applications 122, 124, 126, 128 may be configured to effectuate some or all of the functionality of intent process 110 (and vice versa). Accordingly, in some implementations, intent process 110 may be a purely server-side application, a purely client-side application, or a hybrid server-side/client-side application that is cooperatively executed by one or more of client applications 122, 124, 126, 128 and/or intent process 110.

In some implementations, one or more of client applications 122, 124, 126, 128 may be configured to effectuate some or all of the functionality of collaboration application 120 (and vice versa). Accordingly, in some implementations, collaboration application 120 may be a purely server-side application, a purely client-side application, or a hybrid server-side/client-side application that is cooperatively executed by one or more of client applications 122, 124, 126, 128 and/or collaboration application 120. As one or more of client applications 122, 124, 126, 128, intent process 110, and collaboration application 120, taken singly or in any combination, may effectuate some or all of the same functionality, any description of effectuating such functionality via one or more of client applications 122, 124, 126, 128, intent process 110, collaboration application 120, or combination thereof, and any described interaction(s) between one or more of client applications 122, 124, 126, 128, intent process 110, collaboration application 120, or combination thereof to effectuate such functionality, should be taken as an example only and not to limit the scope of the disclosure.

In some implementations, one or more of users 146, 148, 150, 152 may access computer 112 and intent process 110 (e.g., using one or more of client electronic devices 138, 140, 142, 144) directly through network 114 or through network 118. Further, computer 112 may be connected to network 114 through network 118, as illustrated with phantom link line 154. Intent process 110 may include one or more user interfaces, such as browsers and textual or graphical user interfaces, through which users 146, 148, 150, 152 may access intent process 110.

In some implementations, the various client electronic devices may be directly or indirectly coupled to network 114 (or network 118). For example, client electronic device 138 is shown directly coupled to network 114 via a hardwired network connection. Further, client electronic device 144 is shown directly coupled to network 118 via a hardwired network connection. Client electronic device 140 is shown wirelessly coupled to network 114 via wireless communication channel 156 established between client electronic device 140 and wireless access point (i.e., WAP 158), which is shown directly coupled to network 114. WAP 158 may be, for example, an IEEE 802.11a, 802.11b, 802.11g, 802.11n, 802.11ac, Wi-Fi®, RFID, and/or Bluetooth™ (including Bluetooth™ Low Energy) or any device that is capable of establishing wireless communication channel 156 between client electronic device 140 and WAP 158 (e.g., Zigbee, Z-Wave, etc.). Client electronic device 142 is shown wirelessly coupled to network 114 via wireless communication channel 160 established between client electronic device 142 and cellular network/bridge 162, which is shown by example directly coupled to network 114.

In some implementations, some or all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. Bluetooth™ (including Bluetooth™ Low Energy) is a telecommunications industry specification that allows, e.g., mobile phones, computers, smart phones, and other electronic devices to be interconnected using a short-range wireless connection. Other forms of interconnection (e.g., Near Field Communication (NFC)) may also be used. In some implementations, computer 112 may be directed or controlled by an operator. Computer 112 may be hosted by one or more of assets owned by the operator, assets leased by the operator, and third-party assets. The assets may be referred to as a private, community, or hybrid cloud computing network or cloud computing environment. For example, computer 112 may be partially or fully hosted by a third-party offering software as a service (SaaS), platform as a service (PaaS), and/or infrastructure as a service (IaaS). Computer 112 may be implemented using agile development and operations (DevOps) principles. In some implementations, some or all of computer 112 may be implemented in a multiple-environment architecture. For example, the multiple environments may include one or more production environments, one or more integration environments, one or more development environments, etc.

In some implementations, various I/O requests (e.g., I/O request 115) may be sent from, e.g., client applications 122, 124, 126, 128 to, e.g., computer 112 (and vice versa). Examples of I/O request 115 may include but are not limited to, data write requests (e.g., a request that content be written to computer 112) and data read requests (e.g., a request that content be read from computer 112). Client electronic devices 138, 140, 142, 144 and/or computer 112 may also communicate audibly using an audio codec, which may receive spoken information from a user and convert it to usable digital information. An audio codec may likewise generate audible sound for a user, such as through a speaker, e.g., in a handset of a client electronic device. Such sound may include sound from voice telephone calls, may include recorded sound (e.g., voice messages, music files, etc.) and may also include sound generated by applications operating on the client electronic devices.

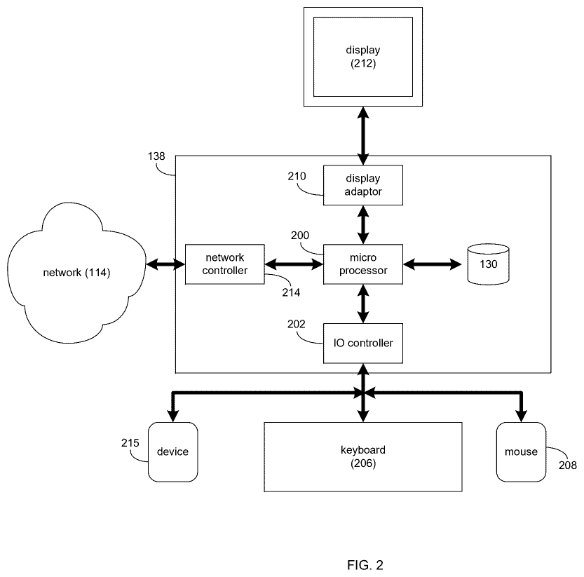

Referring also to the example implementation of FIG. 2, there is shown a diagrammatic view of client electronic device 138. While client electronic device 138 is shown in this figure, this is for example purposes only and is not intended to be a limitation of this disclosure, as other configurations are possible. Additionally, any computing device capable of executing, in whole or in part, intent process 110 may be substituted for client electronic device 138 (in whole or in part) within FIG. 2, examples of which may include but are not limited to computer 112 and/or one or more of client electronic devices 140, 142, 144.

In some implementations, client electronic device 138 may include a processor (e.g., microprocessor 200) configured to, e.g., process data and execute the above-noted code/instruction sets and subroutines. Microprocessor 200 may be coupled via a storage adaptor to the above-noted storage device(s) (e.g., storage device 130). An I/O controller (e.g., I/O controller 202) may be configured to couple microprocessor 200 with various devices (e.g., via wired or wireless connection), such as keyboard 206, pointing/selecting device (e.g., touchpad, touchscreen, mouse 208, etc.), scanner, custom device (e.g., device 215), USB ports, and printer ports. A display adaptor (e.g., display adaptor 210) may be configured to couple display 212 (e.g., touchscreen monitor(s), plasma, CRT, or LCD monitor(s), etc.) with microprocessor 200, while network controller/adaptor 214 (e.g., an Ethernet adaptor) may be configured to couple microprocessor 200 to network 114 (e.g., the Internet or a local area network).

As noted above, the ability to obtain information has improved greatly over the years. As a result, a vast amount of information is available, often times through a single client application. However, having so much information in an application may create a situation where the desired information being search for cannot be located, or where navigating through the client application may be overwhelming. Some applications may enable the user to try and search for whatever it is they are looking for within the application, and if the request is simple enough or if the user uses the precise query recognized by the application, the user may be able to find what they need. Unfortunately, many requests are not as simple, and the application may not be able to understand what the user is searching for. Moreover, the user may not be aware that they are actually searching for something different than what they originally sought out to search for, or that the information may be provided in a better way. Therefore, as will be discussed in greater detail below, the present disclosure may include a chatbot (or similar) application that can more intelligently determine the intent of what the user is searching for and instruct the user how to obtain it. Additionally, in some implementations, the chatbot may preemptively provide the desired information to the user, even without the user requesting it.

As will be discussed below, intent process 110 may at least help, e.g., improve existing technological processes associated with, e.g., natural language understanding intent-based predictions being integrated into the practical application of chatbot applications enabling the preemptive provision of information without requiring the user to request it. It will be appreciated that the computer processes described throughout are integrated into one or more practical applications, and when taken at least as a whole are not considered to be well-understood, routine, and conventional functions.

### The Intent Process

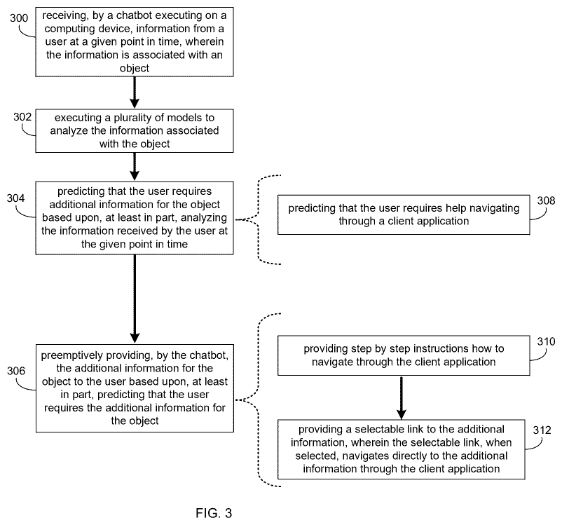

As discussed above and referring also at least to the example implementations of FIGS. 3-6, intent process 110 may receive 300, by a chatbot executing on a computing device, information from a user at a given point in time, wherein the information is associated with an object. Intent process 110 may execute 302 a plurality of models to analyze the information associated with the object. Intent process 110 may predict 304 that the user requires additional information for the object based upon, at least in part, analyzing the information received by the user at the given point in time. Intent process 110 may, via the chatbot, preemptively provide 306 the additional information for the object to the user based upon, at least in part, predicting that the user requires the additional information for the object.

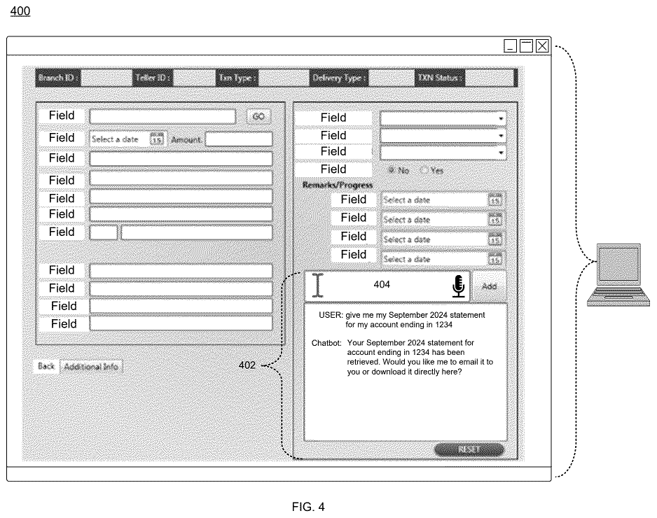

In some implementations, intent process 110 may receive 300, by a chatbot executing on a computing device, information from a user at a given point in time, wherein the information is associated with an object. For instance, and referring at least to the example implementation of FIG. 4, an example user interface (e.g., UI 400) of intent process 110 is shown. It will be appreciated after reading the present disclosure that any UI may be used without departing from the scope of the present disclosure. As such, the particular UI shown should be taken as example only and not to otherwise limit the scope of the present disclosure. In some implementations, UI 400 may be a client application (e.g., client application 128), which may include a chatbot (e.g., chatbot 402). In some implementations, chatbot 402 may be a separate application capable of communicating with client applications 128.

In some implementations, intent process 110 may execute 302 a plurality of models to analyze the information associated with the object. For instance, in some implementations, a first model of the plurality of models executed to analyze the information associated with the object may include a natural language understanding (NLU) model for intent identification, and in some implementations, a second model of the plurality of models executed to analyze the information associated with the object may include an Automated Speech Recognition (ASR) model to transcribe audio of at least a portion of the information that is analyzed by the NLU model. For example, chatbot 402 may generally be defined as a software application designed to simulate human-like conversation through text or voice interactions, and it may be integrated into websites, mobile applications, messaging platforms, or other digital environments to assist users by responding to queries, providing information, or performing tasks. In some implementations, aspects of chatbot 402 may include a simple rule-based systems, and may also include more advanced features that use artificial intelligence (AI) and natural language processing (NLP), as will be discussed in greater detail below.

Rule-based chatbots typically follow a set of pre-defined rules or workflows, responding based on specific keywords or commands, and may be considered somewhat limited in flexibility, handling only the scenarios they've been programmed for. For instance, chatbot 402 may be pre-programmed to perform a list of the top N tasks typically performed at a bank (e.g., check balances, make transactions, or get updates about accounts, or obtain statements). For instance, users 152 may type into a text box (e.g., text box 404) of chatbot 402 something like, “give me my September 2024 statement for my account ending in 1234,” or that phrase may be a spoken phrase transcribed into text box 404. In the example, using a rule-based chatbot, responding to the request “give me my September 2024 statement for my account ending in 1234” may involve following a structured workflow based on pre-defined rules and specific keywords. Chatbot 402 may first identify key phrases in the user's request, such as “statement,” which indicates an account statement request, “September 2024,” specifying the month and year, and “account ending in 1234,” identifying the account in question.

Once chatbot 402 identifies these keywords, it would trigger a pre-defined rule designed to handle account statement requests. This rule may include several example steps: first, confirming the request details by extracting the month, year, and account number; second, verifying the user's permission to access the account, which may involve asking for further authentication like a password, PIN, or security question; and third, connecting to the backend system that holds the user's account information to retrieve the requested statement for the specified account and date.

If all conditions are met, such as successful authentication, a valid account, and the availability of the requested statement, chatbot 402 may generate a response such as: “Your September 2024 statement for account ending in 1234 has been retrieved. Would you like me to email it to you or download it directly here?” If there is an issue, such as an invalid account number, unavailable statement, or failed authentication, chatbot 402 may follow another rule and respond with something like: “I'm sorry, I couldn't find the statement for account ending in 1234 for September 2024. Please ensure the account number is correct or try a different date.” This workflow includes input recognition, where chatbot 402 extracts key information; rule triggering, where chatbot 402 activates a rule for account statement retrieval; action, where it authenticates the user and fetches the statement; and a fallback, where it follows pre-defined error-handling rules if something goes wrong, such as an invalid input or failed verification. This approach allows chatbot 402 to respond systematically to similar requests by mapping inputs to specific actions, though it may struggle with more nuanced requests that fall outside its programmed rules.

In some implementations, intent process 110 may predict 304 that the user requires additional information for the object based upon, at least in part, analyzing the information received by the user at the given point in time. For instance, in some implementations, chatbot 402 may also include an AI-powered chatbot that uses machine learning (ML) and NLP to understand and respond to a wider range of queries, learning from interactions to improve over time and handling dynamic conversations by understanding context, making them more human-like. As will be discussed in greater detail below, chatbot 402 may include features such as, e.g., Natural Language Understanding (NLU), which allows chatbot 402 to comprehend user input in a natural way regardless of phrasing variations; Natural Language Generation (NLG), which enables chatbot 402 to generate human-like responses; and task automation, which allows chatbot 402 to perform specific tasks like booking appointments, answering FAQs, or guiding users through processes, all without requiring human intervention (if such a feature is desired). For instance, an AI-powered chatbot using ML and NLP may handle a request like “give me my September 2024 statement for my account ending in 1234” by interpreting user input through advanced NLP techniques, executing actions based on ML-driven predictions, and continuously learning from interactions to improve future responses. In the first step, chatbot 402 may apply NLU, which combines intent recognition and entity recognition. Intent recognition is used to classify the user's overall objective, such as requesting an account statement, while entity recognition extracts key information such as dates, account numbers, or document types. These models—like BERT (Bidirectional Encoder Representations from Transformers), GPT (Generative Pre-trained Transformer), and frameworks like Rasa NLU—are specifically trained to understand natural language and interpret a wide variety of phrases that users might use. For example, when chatbot 402 encounters the example phrase “give me my September 2024 statement,” it identifies that the intent is to retrieve a financial document, and it pinpoints “September 2024” as the time frame and “account ending in 1234” as the relevant account. These models, such as spaCy or Named Entity Recognition (NER) algorithms, process user input not just by picking out keywords but by understanding how the words are related in context, thus allowing it to handle requests that are phrased in many different ways. For instance, chatbot 402 would still understand the request even if the user said, “Can I get my account statement from September 2024?” or “Show me my September 2024 statement for the account ending 1234.”

In some implementations, chatbot 402 may use contextual processing to manage interactions more effectively. Contextual understanding allows chatbot 402 to track the flow of the conversation and maintain awareness of previously mentioned details, such as the user's authentication status or which account they've been discussing. This is achieved through techniques like contextual embeddings or conversation memory models, which help chatbot 402 retain relevant information over multiple exchanges and sessions. Transformer-based models like Longformer or GPT-4 may be used to keep track of conversational history, ensuring that chatbot 402 does not ask redundant questions and can reference past interactions when appropriate. For example, if the user has already authenticated, chatbot 402 can skip asking for login credentials again and directly move to retrieving the statement. Similarly, if the user is switching between accounts, chatbot 402 can recall which account was last used and apply that knowledge in subsequent actions.

In some implementations, once chatbot 402 has processed the request, it proceeds to execute the necessary actions. First, chatbot 402 may verify the user's identity by integrating with multi-factor authentication (MFA) systems or other security protocols. After successful authentication, chatbot 402 may connect to the backend database, where account and statement data are stored, and fetches the requested statement. ML models such as Decision Trees or Random Forests may be used to ensure that the request is legitimate and to check for any anomalies, such as an incorrect account number or an unavailable statement. This execution may involve API calls to the backend systems, triggering SQL or NoSQL database queries to retrieve the user's financial data. If any part of the request is ambiguous, chatbot 402 may dynamically manage the conversation through dialogue state tracking models like DialoGPT, T5, or reinforcement learning algorithms that continuously optimize the flow of questions and actions based on user behavior.

In some implementations, chatbot 402 may then generate a human-like response using Natural Language Generation (NLG) techniques. Models such as GPT-3 or GPT-4 can be employed to craft natural, context-aware responses tailored to the user's preferences. For example, chatbot 402 may respond with, “I've found your September 2024 statement for your account ending in 1234. Would you like me to email it to you or download it now?” These models ensure that the language used in the response feels conversational and appropriate to the context. Additionally, chatbot 402 may continuously learn from every interaction using reinforcement learning techniques such as Q-learning or Deep Q-Networks (DQNs), enabling it to predict the user's preferences more effectively. For instance, if the user frequently requests email delivery of their statement, chatbot 402 may eventually default to offering email as the preferred method in future interactions.

In some implementations, when errors occur, such as an unavailable statement or an incorrect account number, chatbot 402 may leverage error recovery models and anomaly detection algorithms like Autoencoders or Isolation Forests to handle the situation smoothly. For instance, if a statement for the specified date is not available, chatbot 402 may respond, “I'm sorry, I couldn't find a statement for your account ending in 1234 for September 2024. Could you double-check the account number or the date?” Chatbot 402 may also provide suggestions on what the user might try next, such as selecting a different account or time period. Anomaly detection models are especially useful for identifying unusual requests or patterns, helping chatbot 402 ensure that interactions proceed safely and smoothly.

In some implementations, predicting that the user requires additional information for the object may include predicting 308 that the user requires help navigating through a client application. For instance, assume for example purposes only that the user says, “I can't find the settings option to change my password,” or “I'm having trouble updating my payment information.” In the example, chatbot 402, through intent recognition and entity recognition, may identify key phrases like “can't find” and “trouble updating” as indicators that the user is seeking help navigating a particular part of the application. Chatbot 402 may then infer that the user's intent is not just to change a password or update payment information but also to get assistance navigating the interface. Thus, chatbot 402 may use ML models like BERT or GPT-3 to predict the appropriate follow-up actions, such as guiding the user step-by-step through the process or providing a clickable link to the relevant settings page. By understanding the combination of phrases, chatbot 402 may anticipate the user's need for navigational help and offer assistance before the user explicitly asks for it, enhancing the overall user experience.

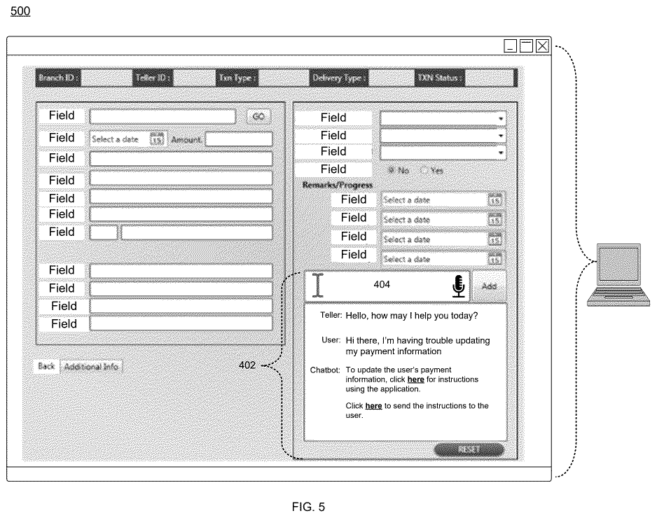

In some implementations, intent process 110 may, via the chatbot, preemptively provide 306 the additional information for the object to the user based upon, at least in part, predicting that the user requires the additional information for the object. For instance, in some implementations, chatbot 402 may have active listening or wakeup word (WuW) activation, which may be used to predict that the user requires a particular object or help navigating the application. For instance, assume for example purposes only that the user walks into a branch to discuss their account with a bank teller. In the example, further assume that it is the teller's computing device that is executing chatbot 402, using the example WuW or phrase of “Hello” or “how may I help you today?” After the initial greetings, when the active listening has been activated by the WuW, the user may say to the teller, “Hi there, I'm having trouble updating my payment information.” In the example, chatbot 402 may use the same techniques discussed above and use the input of the user's statement to automatically query and provide a similar response as discussed above, as shown in the example UI 500 implementation of FIG. 5.

In some implementations, preemptively providing, by the chatbot, the additional information for the object to the user may include providing 310 step by step instructions how to navigate through the client application and in some implementations, preemptively providing, by the chatbot, the additional information for the object to the user may include providing 312 a selectable link to the additional information, wherein the selectable link, when selected, may navigate directly to the additional information through the client application. For instance, in some implementations, chatbot 402 may provide the teller with the option to send the requested information to the user's client electronic device, as shown in UI 500. In some implementations, chatbot 402 may simply provide the step by step instructions to the teller (or user). In some implementations, as also shown in FIG. 5, chatbot 402 may provide a link in UI 500 that when selected, retrieves the additional information (e.g., the step by step instructions or requested statements, etc.) or may navigate directly to the part of the UI where the additional information can be found.

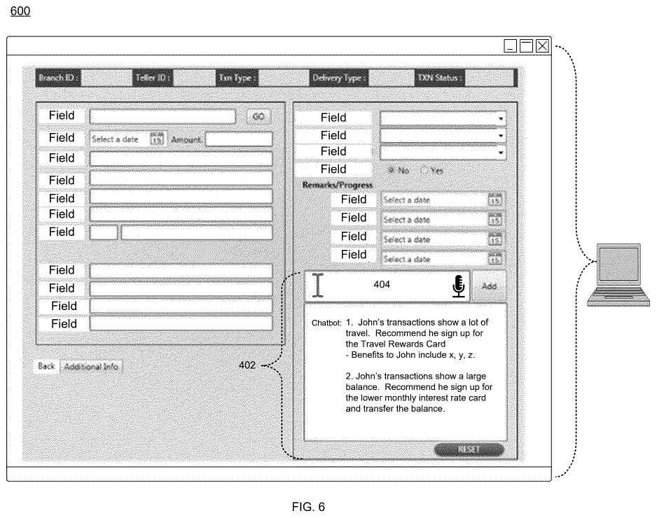

In some implementations, the additional information for the object may include a recommendation for another object. For instance, and referring to the example implementation of FIG. 6, an example UI 600 is shown. In some implementations, chatbot 402 may analyze transactions associated with the user's account that may be matched to one or more objects. For instance, UI 600 may include pertinent information that may enable the customer service representative/teller to recommend certain products to the user. For instance, if the top X transactions include a threshold number of transactions that show the user does a lot of travel, chatbot 402 may match those transactions to an object (e.g., a credit card that will provide more awards for travel), providing an opportunity for the customer service representative/teller to recommend that he sign up for that credit card. As another example, if the top X transactions showing a high account balance, chatbot 402 may suggest that the customer service representative/teller recommend that he sign up for a credit card with a lower monthly interest rate and transfer the high balance.

The terminology used herein is for the purpose of describing particular implementations only and is not intended to be limiting of the disclosure. As used herein, the singular forms “a”, “an” and “the” are intended to include the plural forms as well, including any steps performed by a/the computer/processor, unless the context clearly indicates otherwise. As used herein, the phrase “at least one of A, B, and C” should be construed to mean a logical (A OR B OR C), using a non-exclusive logical OR, and should not be construed to mean “at least one of A, at least one of B, and at least one of C.” As another example, the language “at least one of A and B” (and the like) as well as “at least one of A or B” (and the like) should be interpreted as covering only A, only B, or both A and B, unless the context clearly indicates otherwise. It will be further understood that the terms “comprises” and/or “comprising,” when used in this specification, specify the presence of stated features, integers, steps (not necessarily in a particular order), operations, elements, and/or components, but do not preclude the presence or addition of one or more other features, integers, steps (not necessarily in a particular order), operations, elements, components, and/or groups thereof. Example sizes/models/values/ranges can have been given, although examples are not limited to the same.

The terms (and those similar to) “coupled,” “attached,” “connected,” “adjoining,” “transmitting,” “communicating,” “receiving,” “connected,” “engaged,” “adjacent,” “next to,” “on top of,” “above,” “below,” “abutting,” and “disposed,” used herein is to refer to any type of relationship, direct or indirect, between the components in question, and may apply to electrical, mechanical, fluid, optical, electromagnetic, electromechanical or other connections, including logical connections via intermediate components (e.g., device A may be coupled to device C via device B). Additionally, the terms “first,” “second,” etc. are used herein only to facilitate discussion, and carry no particular temporal or chronological significance unless otherwise indicated. The terms “cause” or “causing” means to make, force, compel, direct, command, instruct, and/or enable an event or action to occur or at least be in a state where such event or action is to occur, either in a direct or indirect manner. The term “set” does not necessarily exclude the empty set—in other words, in some circumstances a “set” may have zero elements. The term “non-empty set” may be used to indicate exclusion of the empty set—that is, a non-empty set must have one or more elements, but this term need not be specifically used. The term “subset” does not necessarily require a proper subset. In other words, a “subset” of a first set may be coextensive with (equal to) the first set. Further, the term “subset” does not necessarily exclude the empty set—in some circumstances a “subset” may have zero elements.

The corresponding structures, materials, acts, and equivalents (e.g., of all means or step plus function elements) that may be in the claims below are intended to include any structure, material, or act for performing the function in combination with other claimed elements as specifically claimed. While the disclosure describes structures corresponding to claimed elements, those elements do not necessarily invoke a means plus function interpretation unless they explicitly use the signifier “means for.” Unless otherwise indicated, recitations of ranges of values are merely intended to serve as a shorthand way of referring individually to each separate value falling within the range, and each separate value is hereby incorporated into the specification as if it were individually recited. While the drawings divide elements of the disclosure into different functional blocks or action blocks, these divisions are for illustration only. According to the principles of the present disclosure, functionality can be combined in other ways such that some or all functionality from multiple separately-depicted blocks can be implemented in a single functional block; similarly, functionality depicted in a single block may be separated into multiple blocks. Unless explicitly stated as mutually exclusive, features depicted in different drawings can be combined consistent with the principles of the present disclosure. Moreover, although this disclosure describes and depicts respective implementations herein as including particular components, elements, feature, functions, operations, or steps (and arrangements thereof), any of these implementations may include any combination, arrangement, or permutation of any of the components, elements, features, functions, operations, or steps described or depicted anywhere herein that a person having ordinary skill in the art would comprehend after reading the present disclosure. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

The description of the present disclosure has been presented for purposes of illustration and description but is not intended to be exhaustive or limited to the disclosure in the form disclosed. After reading the present disclosure, many modifications, variations, substitutions, and any combinations thereof will be apparent to those of ordinary skill in the art without departing from the scope and spirit of the disclosure. The implementation(s) were chosen and described in order to explain the principles of the disclosure and the practical application, and to enable others of ordinary skill in the art to understand the disclosure for various implementation(s) with various modifications and/or any combinations of implementation(s) as are suited to the particular use contemplated. The features of any dependent claim may be combined with the features of any of the independent claims or other dependent claims.

Having thus described the disclosure of the present application in detail and by reference to implementation(s) thereof, it will be apparent that modifications, variations, and any combinations of implementation(s) (including any modifications, variations, substitutions, and combinations thereof) are possible without departing from the scope of the disclosure defined in the appended claims.

What is claimed is:

1. A computer-implemented method, comprising:
receiving, by a chatbot executing on a computing device from a user at a given point in time, information associated with an object;
executing a plurality of models to analyze the information associated with the object;
predicting that the user requires additional information for the object based upon, at least in part, analyzing the information received by the user at the given point in time; and
preemptively providing, by the chatbot, the additional information for the object to the user based upon, at least in part, predicting that the user requires the additional information for the object.

2. The computer-implemented method of claim 1, wherein a first model of the plurality of models executed to analyze the information associated with the object includes a natural language understanding (NLU) model for intent identification.

3. The computer-implemented method of claim 2, wherein a second model of the plurality of models executed to analyze the information associated with the object includes an Automated Speech Recognition (ASR) model to transcribe audio of at least a portion of the information that is analyzed by the NLU model.

4. The computer-implemented method of claim 1, wherein predicting that the user requires additional information for the object includes predicting that the user requires help navigating through a client application.

5. The computer-implemented method of claim 4, wherein preemptively providing, by the chatbot, the additional information for the object to the user includes providing step by step instructions how to navigate through the client application.

6. The computer-implemented method of claim 4, wherein preemptively providing, by the chatbot, the additional information for the object to the user includes providing a selectable link to the additional information, wherein the selectable link, when selected, navigates directly to the additional information through the client application.

7. The computer-implemented method of claim 1, wherein the additional information for the object includes a recommendation for another object.

8. A computer program product residing on a computer readable storage medium having a plurality of instructions stored thereon which, when executed across one or more processors, causes at least a portion of the one or more processors to perform operations comprising:
receiving, by a chatbot executing on a computing device from a user at a given point in time, information associated with an object;
executing a plurality of models to analyze the information associated with the object;
predicting that the user requires additional information for the object based upon, at least in part, analyzing the information received by the user at the given point in time; and
preemptively providing, by the chatbot, the additional information for the object to the user based upon, at least in part, predicting that the user requires the additional information for the object.

9. The computer-implemented method of claim 8, wherein a first model of the plurality of models executed to analyze the information associated with the object includes a natural language understanding (NLU) model for intent identification.

10. The computer-implemented method of claim 9, wherein a second model of the plurality of models executed to analyze the information associated with the object includes an Automated Speech Recognition (ASR) model to transcribe audio of at least a portion of the information that is analyzed by the NLU model.

11. The computer-implemented method of claim 8, wherein predicting that the user requires additional information for the object includes predicting that the user requires help navigating through a client application.

12. The computer-implemented method of claim 11, wherein preemptively providing, by the chatbot, the additional information for the object to the user includes providing step by step instructions how to navigate through the client application.

13. The computer-implemented method of claim 11, wherein preemptively providing, by the chatbot, the additional information for the object to the user includes providing a selectable link to the additional information, wherein the selectable link, when selected, navigates directly to the additional information through the client application.

14. The computer-implemented method of claim 8, wherein the additional information for the object includes a recommendation for another object.

15. A computing system including one or more processors and one or more memories configured to perform operations comprising:
receiving, by a chatbot executing on a computing device from a user at a given point in time, information associated with an object;
executing a plurality of models to analyze the information associated with the object;
predicting that the user requires additional information for the object based upon, at least in part, analyzing the information received by the user at the given point in time; and
preemptively providing, by the chatbot, the additional information for the object to the user based upon, at least in part, predicting that the user requires the additional information for the object.

16. The computer-implemented method of claim 15, wherein a first model of the plurality of models executed to analyze the information associated with the object includes a natural language understanding (NLU) model for intent identification.

17. The computer-implemented method of claim 16, wherein a second model of the plurality of models executed to analyze the information associated with the object includes an Automated Speech Recognition (ASR) model to transcribe audio of at least a portion of the information that is analyzed by the NLU model.

18. The computer-implemented method of claim 15, wherein predicting that the user requires additional information for the object includes predicting that the user requires help navigating through a client application.

19. The computer-implemented method of claim 18, wherein preemptively providing, by the chatbot, the additional information for the object to the user includes providing step by step instructions how to navigate through the client application.

20. The computer-implemented method of claim 18, wherein preemptively providing, by the chatbot, the additional information for the object to the user includes providing a selectable link to the additional information, wherein the selectable link, when selected, navigates directly to the additional information through the client application.
